(19) United States
(12) Patent Application Publication
(10) Pub. No.: US 2003/0069378 A1
(43) Pub. Date: Apr. 10, 2003

(54) Filtration efficiency

(76) Inventors: Mohan L. Sanduja, Brooklyn, NY (US); Carl Horowitz, Brooklyn, NY (US); Lina Zilberman, Brooklyn, NY (US); Paul Thottathil, Brooklyn, NY (US)

Correspondence Address: NIXON & VANDERHYE P.C., 1100 North Glebe Road, 8th Floor, Arlington, VA, 22201, US

(21) Appl. No.: 09/844,709

(22) Filed: Apr. 30, 2001

Related U.S. Application Data
(60) Provisional application No. 60/200,343, filed on Apr. 28, 2000.

(51) Int. Cl. C08G 77/00

(52) U.S. Cl. 528/10

(57) ABSTRACT

A polymeric coating composition chemically grafts to cellulose or synthetics, and the resulting product serves as a filter in a filtration system which keeps the filtered liquid or gas clean by removing soot, solids, liquids and other contaminants, thus maximizing the life of equipment or engines. The coating is developed using chemical grafting that involves the use of monomers, prepolymers, catalysts, a graft initiator system and/or other ingredients. The resulting coating is used to treat cotton, other cellulose materials, synthetic materials and combinations thereof, and provides for graft-polymerization, thereby forming a polymeric film which is chemically bonded to the cotton fiber, other cellulose fibers, synthetics or combinations thereof with excellent adhesion, thereby imparting all the desired properties to the fiber in terms of increased filtration efficiency.

### FIELD OF THE INVENTION

This application is based upon and claims the benefit of U.S. Provisional Application No. 60/200,343, filed Apr. 28, 2000, the entire content of which is hereby incorporated by reference in this application.

The present invention relates generally to a coating composition for the treatment of filtration materials, and corresponding processes.

### DETAILED DESCRIPTION OF THE INVENTION

The invention relates to a coating composition for the treatment of cotton (or other cellulose fibers or synthetics useful for filtration, in individual or sheet form), and the processes of manufacturing the coating composition and coated materials. The invention yields filter materials with chemical-high temperature resistance, excellent non-leaching properties and increased filtration efficiency for the removal of carbon, soot, silica, metal particles and other contaminants from fuel, oil, lubricants in general, coolants or air, associated with motor vehicles, engines, hydraulic equipment, automatic transmissions or related applications.

The invention is particularly described with respect to cotton fibers (including long strand compressed and uncompressed cotton), but it is to be understood that the invention is also eminently suited for use with other cellulose fibers (e.g., wood or other paper making fibers), synthetics (e.g., acrylics or polyesters), and mixtures or combinations thereof. The coating composition may be applied to the fibers alone or to a nonwoven sheet or web made from the fibers.

The treated fibers, and nonwoven sheets or the like made therefrom, are particularly suitable for use in an oil reclamation devices, for example, like those manufactured by Puradyn Filter Technologies, Inc. of Boynton Beach, Fla., and as shown in U.S. Pat. Nos. 5,630,912, 4,943,352, 4,289,583, 4,227,969, and 4,189,351 (the disclosures of which are hereby incorporated by reference herein). The invention is also suitable for use with oil filters per se, and other components (including cotton wadding or other fibers) as shown in U.S. Pat. Nos. 5,591,330 and 5,718,258 (the disclosures of which are hereby incorporated by reference herein). The invention is suitable for use with primary and secondary full flow oil filters—for example, those where approximately 1400 gallons per hour of oil flow through the filter (which can be made of paper and non-paper type materials), primary and secondary fuel filters—for example, those where approximately 10 gallons per hour of fuel flow through the filter (which can be made of paper and non-paper type materials), transmission filters (which can be made of paper and non-paper type materials), coolant filters (which can be made of paper and non-paper filter materials), air filters (which can be made of paper and non-paper filter materials), and other types of filters.

In one embodiment, the invention relates to a polymeric coating composition for the treatment of cotton fiber that serves as a filter in an oil filtration system which keeps the oil clean by removing soot, solids, liquids and other contaminants, maintains the intended viscosity, drastically reduces additive consumption and enables the oil to provide maximum lubricity, cooling and sealing qualities, thus maximizing the life of the engine or equipment. The coating is developed using technology of chemical grafting that involves the use of monomers, prepolymers, catalyst, graft initiator system and other ingredients. The resulting coating is used to treat cotton, other cellulose materials, synthetic materials and combinations thereof, and provides for graft-polymerization, thereby forming a polymeric film which is chemically bonded to the cotton fiber, other cellulose fibers, synthetics or combinations thereof with excellent adhesion, thereby imparting all the desired properties to the fiber in terms of increased filtration efficiency, for example, in an oil filtration system.

Among an oil's primary functions are lubricating and cooling equipment parts and engines. Oil reduces friction, enabling equipment and engines to operate smoothly and efficiently. The cleaner the oil, the longer the equipment and engines will last. There are many different kinds of oils, each formulated for a specific purpose and environment, and to have optimum viscosity and the most effective blend of additives. Although no two oils are exactly alike, all have one thing in common—they are susceptible to contamination. While serving its intended purpose, oil is exposed to high temperatures, carbon, soot; silica, metal particles, water, fuel and glycol. As oil becomes increasingly contaminated, oil life decreases until it can no longer protect, cool and lubricate the moving parts of the equipment or engine. When contamination is allowed to reach this level, the oil must be changed in order to minimize the equipment or engine damage. However, even the most careful change of oil leaves contaminants behind in the equipment or engine.

The most effective preventive maintenance development for equipment and engines is the improved/increased filtration efficiency of the filter element, and, hence, the need to treat the substrate material that is used as a filter element in an oil filtration system. Among the most important benefits that may result from the treated filter element in the oil filtration system are the following: extended engine life, the reduction of oil purchase and disposal costs, the safe extension of oil drain intervals, the removal of problematic water, fuel and glycol, the removal and/or reduction of solid contaminants, increased engine and equipment efficiency due to clean or cleaner oil, and the overall improvement of engine efficiency.

The inventive graft formulation for the treatment of cotton fibers, other cellulose fibers, synthetics and combinations thereof provides: temperature resistance, chemical resistance, non-leaching properties, and increased filtration efficiency when used as a filter element in a high efficiency purification system for the removal of carbon, soot, silica, metal particles and other contaminants from oil, fuel, lubricants or air. The present invention involves the treatment of cotton fibers, other cellulose fibers, synthetics, or combinations thereof with a coating formulation comprising chemically grafting monomers/prepolymers, thereby resulting in a polymeric film strongly bonded to the cotton fiber, other cellulose fiber, synthetic for combination thereof. The treated material can not only be cotton, but also paper and synthetic paper, or a blend or combination of these materials.

The monomers and prepolymers are selected so that the polymeric film grafted onto the cotton fiber, other cellulose fiber, synthetics or combinations thereof results in an increase in filtration efficiency in the filtration system, along with increased temperature and chemical resistance, and non-leaching properties, i.e., the chemically grafted composition will not leach from the treated cotton or other material back into the filtered oil, fuel, lubricant or air. Using grafting technology, as discussed below, there is provided a type of chemical grafting via free radicals formation and subsequent attachment of monomers/prepolymers to the substrate material, so that the coating composition will be permanently attached to the cotton, other cellulose, synthetic or combination substrate without affecting the inherent structured properties of the cotton, other cellulose, synthetic or combination.

Mechanism of Chemical Grafting of Monomers/Prepolymers

The following mechanism is explained with respect to cotton, but is equally applicable to other cellulose materials, synthetic materials (acrylics or polyesters) or combinations thereof.

Cotton is the major textile fiber and an importance source of cellulose which constitutes 88-96% of the fibrous material. Cellulose is a natural carbohydrate high polymer (polysaccharide) consisting of anhydroglucose units joined by an oxygen linkage to form long molecular chains that are essentially linear (FIG. 1).

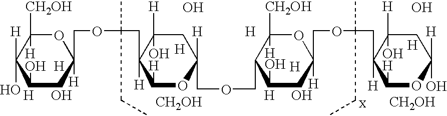

### Cellulose Molecule (FIG. 1)

Chemical grafting of cellulose can be described as a process consisting of activating the cellulose molecule, attaching monomers to the reactive sites followed by chain propagation, whereby polymer branches are formed that are attached to the main cellulose molecule.

In the case of a cellulose molecule, the chemical grafting is carried out via the abstraction of a hydrogen atom from the hydroxyl group of the molecule. The cellulose molecules have active labile hydrogen atoms in the groups (—CH₂OH) which can be activated in the presence of a graft initiator (“G.I.” or “GI”) giving rise to free radicals (“x”). The free radicals thus produced in the process initiate graft polymerization. The series of reaction steps involved in graft polymerization of cellulose fibers are as follows:

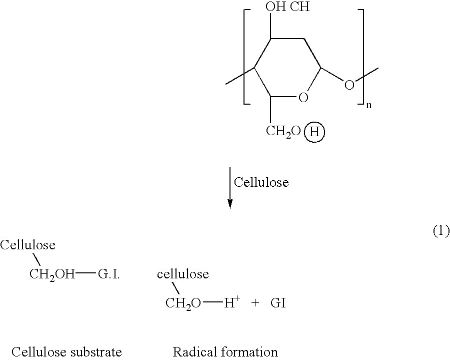

In the presence of vinyl monomers, the cellulose radical produced in the process initiates the graft polymerization:

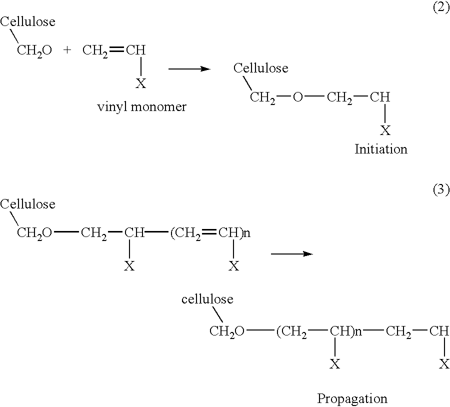

Where x is either —OR or

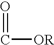

And where R is allyl, phenyl or alkyl groups, said alkyl group typically being of from 1 to 10 carbon atoms.

The graft initiator ion starts the action and the whole process behaves like an autocatalytic one. A very small amount of graft initiator ion (10-100 ppm) is therefore sufficient to carry out the process of graft polymerization.

All of the foregoing reactions take place in the presence of peroxide which concurrently regenerates the graft initiator forming a free radical as shown in the reaction below:

ROOH+GI→RO^{·}+OH⁻+GI⁺ (4)

Peroxide

Where R is allyl, phenyl or alkyl group, said alkyl group typically being of from 1 to 10 carbon atoms.

The graft propagation shown in step (3) above may be terminated by radical combination, which may occur in one of two ways—via step (5) or step (6):

Step (5) shows the final product when termination is a result of a combination of one of the free radicals with one of the polymerized substrate radicals.

Step (6) shows the product when termination is caused by combination of two polymerized substrates radicals.

The end product of both the steps (5) and (6) is the grafted cellulose fiber with all the desired properties imparted to it.

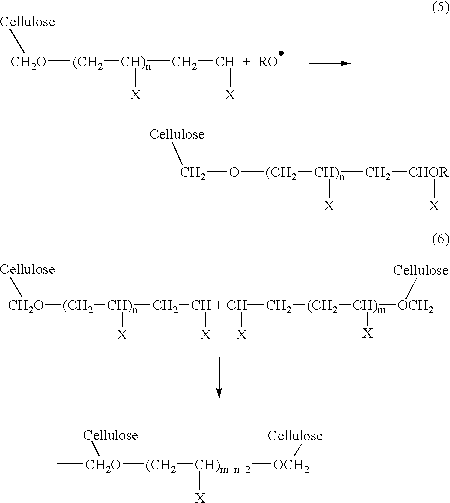

The graft initiator may consist of the metal ions system Fe⁺⁺⁺, Fe⁺⁺, Ag⁺, Co⁺⁺ or Cu⁺⁺. The peroxide should be chosen from the water soluble catalysts such as hydrogen peroxidem, urea peroxide, ammonium persulfate, potassium persulfate and/or sodium metabisulfate. The monomers and prepolymers have side functional groups X, which may react between themselves and with additional prepolymers included into the formulation, forming a graft cross-linked organic coating. The functional groups of the monomers and prepolymers should consist of hydroxyl groups, carboxyl groups, secondary and/or tertiary amino groups. The molecular ratio of the functional groups of the reactive components are so adjusted that no free groups are left after the reaction is over. The physical and chemical properties of the prepolymers and monomers included in the formulation have been selected so that, when grafted onto the cotton fabric, they impart high temperature resistance, chemical resistance, non-leaching properties, and increased filtration efficiency for removal of carbon, soot, silica, metal particles and other contaminants from, for example, oil in an oil filtration system.

The chemical grafting of this invention includes prepolymers, monomers and/or copolymers.

A greater understanding of this invention will be achieved by careful consideration of the following non-limiting Examples.

### EXAMPLE 1

Formulation

| Ingredients | Parts By Weight |
|---|---|
| Freetex 695-polyacrylamide polymer −1.5 | |
| Hot water (80° C.) −98.5 | 0.1 |
| Troysan polyphase AF-1 (bacteriacide) −0.1 | |
| Deionized water (DIW) | 34.5 |
| Mono 2-acrylamido-2-methyl propane sulfonic | 40.0 |
| acid salt 50% aqueous solution (AMPS 2403) | |
| Isopropyl alcohol (IPA) | 37.5 |
| Monomer HEMA-2-hydroxy ethyl methacrylate | 10.5 |
| Ammonium persulfate (10% solution) | 1.0 |
| Sodium metabisulfate (10% solution) | 1.0 |
| Hydrogen peroxide (0.1% solution) | 0.01 |
| Silver nitrate (0.1% solution) | 0.01 |

The foregoing ingredients were used in the stated amounts and in the stated order as follows. First, the preselected amount of Freetex 695 is wet with methanol for about fifteen to thirty minutes under ambient conditions. Then, the wet Freetex 695 (without any excess methanol) is added to the preheated “Hot water” identified above (80° C.) in a container with continuous agitation until it is dissolved. The resulting solution is allowed to cool (for about ten minutes) to room temperature. Next, the bacteriacide (Troysan polyphase AF-1) is added to the solution. This resulting Freetex mixture is then premixed with the deionized water. All of the other ingredients are then added to the mixture in the stated amounts and in the stated order under ambient conditions and while agitating the mixture (e.g., using mild agitation in a mixer). After all of the ingredients are well mixed (approximately five to ten minutes), the resulting formulation is ready for treating the cotton fibers.

The pot life of the resulting formulation is about five to six hours. Thus, the cotton fibers should be treated with the resulting formulation prior to five to six hours from its creation. If the formulation begins to gel, it should not be used.

The resulting formulation was applied to commercially available 100% long strand unbleached, compressed cotton, i.e., the formulation was applied to cotton by dipping or immersing the cotton in the formulation, squeezing the cotton to remove excess formulation (e.g., squeezing the cotton by inserting it into a ringer having two rotating rollers), and curing the graft coated cotton at about 250 degrees F. (about 121 degrees C.) for about thirty (30) minutes in a standard commercially available oven. The treated cotton was then used as a filter material.

### EXAMPLE 2

Formulation

| Ingredients | Parts By Weight |
|---|---|
| PKFE (30% in MEK/cellosolve acetate, 1:1) | 30.0 |
| Polyketone K-1717B (30% in cellosolve acetate) | 7.5 |
| Cymel 303 | 5.0 |
| MEK | 35.0 |
| Cellosolve Acetate | 35.0 |
| Butyl Carbitol | 10.0 |
| BYK 300 | 0.04 |
| Cycat 4040 | 0.05 |
| Silwet L77 | 0.25 |
| Silane A-1100 | .016 |
| PS 072-KG (Dimethysiloxane, Ethyl Oxide | 1.7 |
| Propylene Oxide copolymer) | |
| Silver perchlorate (0.1% in MEK) | 0.01 |

Using the above ingredients and amounts (based on grams), the primary resin (PKFE) was dissolved in 30% MEK/cellosolve acetate 1:1, and was placed with polyketone prepolymer (polyketone K-1717B 30% in cellosolve acetate) in a container. To this combination, the above identified monomers, prepolymers, catalyst, graft initiator and other ingredients were added to the container. The ingredients were used in the concentration ratios and in the order indicated above. Under ambient conditions, the contents were stirred to a uniform solution. The resulting formulation was then applied to commercially available 100% long strand unbleached, compressed cotton, i.e., the formulation was applied to cotton by dipping or immersing the cotton in the formulation, squeezing the cotton to remove excess formulation, and curing the cotton at about 250 degrees F. for about thirty (30) minutes in a standard commercially available oven. The treated cotton was then used as a filter material.

### EXAMPLE 3

Formulation

| Ingredients | Parts By Weight |
|---|---|
| Helastic WO-8061 | 52.0 |
| Helastic WO-8079 | 10.0 |
| DIW | 38.0 |
| Ecco-Res u-78 | 15.0 |
| APS v-soft | 10.0 |
| APG-9kn | 10.0 |
| Ammonium 14% in water (adjust pH to 8.0-8.5) | 1.0 |
| Silver Nitrate (0.1% in H₂O) | 0.1 |
| Urea peroxide (0.1% in H₂O) | 0.1 |

Like the process of the foregoing example, a precalculated quantity of aqueous acrylic resin binder was placed in a container. The monomers, prepolymers, catalyst, graft initiator system and other ingredients of the above formulation were added to the container. The ingredients were used in the concentration ratios and in the order indicated above. Under ambient conditions, the contents were stirred to a uniform solution. The resulting formulation was then used to treat cotton in the same manner as described above, including curing at 250 degrees F. for thirty (30) minutes. The treated cotton was then used as a filter material.

### EXAMPLE 4

Formulation

| Ingredients | Parts By Weight |
|---|---|
| AMPS 2403 Monomer (50% aqueous solution) | 30.0 |
| IPA | 25.0 |
| DIW | 23.0 |
| HEMA (97% solution) | 7.0 |
| 10% ammonium persulfate | 1.0 |
| 10% sodium metabisulfate | 1.0 |
| Freetex 695 (wet with methanol) −1.5 | 0.1 |
| Hot water (80 degrees C.) −98.5 | |
| dissolve Freetex and hot water with agitation, | |
| cool down and add: | |
| Troysan Polyphase AF-1 −0.1 | |

Like the process of the foregoing example, a precalculated quantity of monomer, AMPS 2403—(2-Acrylamido-2-Methyl Propane Sulfonic Acid Sodium Salt 50% aqueous solution), was placed in a container. The other ingredients of the above formulation were then added to the container. The ingredients were used in the concentration ratios and were added in the order indicated above. Under ambient conditions, the contents were stirred to a uniform solution. The resulting formulation was then used to treat cotton in the same manner as described above, including curing at 250 degrees F. for thirty (30) minutes. The treated cotton was then used as a filter material.

In the foregoing examples, a specified quantity of cotton fiber (5-10 pounds or more, as is desired) was immersed in the formulation under ambient conditions and within six to eight hours of preparing the formulation. The cotton was then removed from the immersion, squeezed to remove excess formulation, and then subjected to curing at 250 degrees F. for 30-40 minutes. The cured cotton fiber is then ready to be used as a filter element for the filtering of oils, fuels, lubricants, coolants air and similar fluids and gases. It is preferred to the treat the cotton (or other cellulose material, synthetic material or combination thereof) with the formulation immediately after production of the chemical grafting formulation.

In the foregoing examples, the trade named products have the following generic descriptions and functions:

Cymel 303 Resin—hexamethoxymethyl melamine, crosslinking agent for phenoxy resin and polyketone, thereby giving strength to the fiber.

Silane A-1100—gamma-aminopropyltriethoxysilane, adhesion promoter.

BYK 300—wetting agent.

Silwet L77—surfactant and wetting agent, helps to maintain the rheology of the formulation.

Cycat 4040—paratoluene sulfonic acid, catalyst for low temperature reactions.

PS072-KG—hydrophilic silicone, helps to increase the hydrophilic properties of the fiber.

Helastic WO-8061—aqueous acrylic resin binder (acrylic copolymer), acts as a binder

Helastic WO-8079—aqueous suspension of a high molecular weight silicone, it is an acrylic copolymer that acts as a binder.

Ecco-Res U-78—aliphatic polyurethane, acts as binder.

APS V-soft—silicone softener to impart softness to the fiber.

APG 9kn—fluoro chemical, acts as a lubricant so as to increase the flow of the oil.

Freetex 695—melamine prepolymer, a polyacrylamide, having a high mean molecular weight of about sixteen million, a bulk density of about 675-770 kg/M³, a 5.5-7.5 pH of 0.2% solution at 25° C., and which acts as a binder as well as absorber of solid particles from the oil.

AMPS 2403 monomer—2-acrylamido-2-methylpropanesulfonic acid sodium salt (50% aqueous solution), having a molecular weight of 229. It has the following formula. It is a monomer which imparts rheology control in terms of hydrolytic and thermal stability.

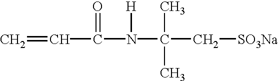

HEMA—2-hydroxyethyl methacrylate, a monomeric methacrylate ester. It has the following formula.

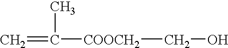

Sodium metabisulfite, 97%—sodium metabisulfite, also known as disodium disulfite and disodium pyrosulfite. It is a catalyst.

Ammonium persulfate, 98%—ammonium peroxodisulfate, also known as ammonium peroxydisulfate. It is a catalyst.

Troysan polyphase AF-1, EPA Registration No. 5383-18, is a broad spectrum, liquid, non-metallic fungicide, bacteriacide; its active ingredient is 3-iodo-2-propynyl butyl carbamate. Troysan polyphase is manufactured under U.S. Pat. No. 3,923,870 and 4,276,211 (the disclosures of which are hereby incorporated by reference herein).

PKFE—phenoxy resin, having a high molecular weight and low residual volatiles. It has the following formula.

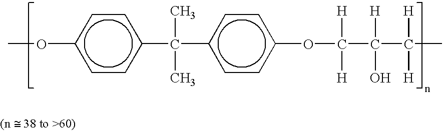

Cotton—100% long strand unbleached, compressed cotton.

Utilizing the methods described above of chemically grafting monomers and prepolymers to cotton, other cellulose materials, synthetics (e.g., acrylics or polyesters), or combinations of the foregoing by a free radicals formation, fibers having increased filtration efficiency, high temperature and chemical resistance, and non-leaching properties are produced. The fibers may be in compressed form or loose form, and used in those forms as a filtration media (such as disclosed for the loose cotton fibers in U.S. Pat. No. 5,591,330, the disclosure of which is hereby incorporated by reference herein), or the fibers may be produced into a nonwoven web or sheet form, with grafting taking place either prior to nonwoven formation, or, where appropriate, after formation of the nonwoven. Nonwoven sheets so produced may then be used as a filtration media, for example, in oil, fuel, lubricant, coolant or air filters, particularly for vehicular use, but also for use with hydraulic equipment, automatic transmissions, engines, whether stationary or mobile, or the like.

The invention also relates to the filtration media produced by practice of the method as described above, the filtration media comprising: compressed or uncompressed cotton, other cellulose fibers, synthetics (e.g., acrylic or polyester fibers), or combinations of the foregoing; substantially loose cotton, other cellulose fibers, or acrylic or polyester fibers, or the like; or such fibers formed into nonwoven webs utilizing conventional techniques. The filtration media so produced may be used in any of the systems or devices as described in the aforementioned patents. The invention also relates to the systems or products of the aforementioned patents which utilize the filtration media according to the present invention.

The percentage of polymers, monomers, graft initiator systems and catalysts depend upon the particular fibers treated, the particular circumstances under which the fibers will be used for filtration, what form the fibers will be in during filtration, and other variables. For example, for one particular coating system, a formulation may be utilized comprising about 30-50% by weight (e.g., about 38%) aqueous acrylic resin binder, about 3-11% (e.g., about 7%) high molecular weight silicone in an aqueous suspension, about 20-40% (e.g., about 28%) deionized, distilled or otherwise pure water, about 5-16% (e.g., about 11%) binder (such as an aliphatic polyurethane), and about 3-11% (e.g., about 7%) each of a softener to impart softness to the fibers (e.g., a silicone softener), and lubricant to increase the flow rate of the oil (e.g., a fluoro chemical), and small amounts (less than 1% of each) of a catalyst and a graft initiator (such as urea peroxide and silver nitrate). Preferably, the pH is adjusted so that it is basic, with a preferred pH range of about 7.5-9, e.g., about 8.25. Curing is preferred, typically at a temperature of between about 100-130° C., but low enough so as not to adversely affect the fibers being treated.

Monomers in the range of 0.1 to 50% may be used in the composition.

In another example of a coating system, a formulation may be utilized comprising about less than 1% by weight (e.g., about 0.08%) of a polyacrylamide prepolymer dissolved in hot water (between 60-100° C.) with a bacteriacide added thereto, about 20-40% (e.g., about 28%) deionized, distilled or otherwise pure water, about 20-40% (e.g., about 32%) mono 2-acrylamido-2-methyl propane sulfonic acid salt 50% aqueous solution, about 20-40% (e.g., about 30%) solvent such as isopropyl alcohol, about 4-15% (e.g., about 8%) monomer ester such as 2-hydroxy ethyl methacrylate, about less than 2% (e.g., about 0.8%) of a catalyst such as ammonium persulfate (10% solution), about less than 2% (e.g., about 0.8%) of a catalyst such as sodium metabisulfate (10% solution), about less than 2% (e.g., about 0.008%) of a catalyst such as hydrogen peroxide (0.1% solution), and about less than 2% (e.g., about 0.008%) of a graft initiator such as silver nitrate (0.1% solution). Curing is preferred, typically at a temperature of between about 100-130° C., but low enough so as not to adversely affect the fibers being treated.

In this disclosure, it is to be understood that all ranges and formulation amounts are approximate, and that all smaller ranges within a broad range are specifically provided. For example, an amount of deionized water between about 20-40% includes 21-36%, 30-39%, 25-28%, and all other narrower ranges within the broad range. The same holds true for all other ranges used in this disclosure.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A coating composition for the chemical grafting of an oil, fuel, coolant or air filter material, the composition comprises:
about 30-50% by weight of an aqueous acrylic resin,
about 3-11% by weight of a high molecular weight silicone in an aqueous suspension,
about 20-40% by weight of deionized, distilled or otherwise pure water,
about 5-16% by weight of a binder,
about less than 1% by weight of a catalyst, and
about less than 1% by weight of a graft initiator.

2. The composition according to claim 1, wherein the aqueous acrylic resin is an acrylic copolymer.

3. The composition according to claim 1, wherein the binder is an aliphatic polyurethane.

4. The composition according to claim 1, wherein the catalyst is at least one selected from hydrogen peroxidem, urea peroxide, ammonium persulfate, potassium persulfate, sodium metabisulfate and mixtures thereof.

5. The composition according to claim 1, wherein the graft initiator is at least one selected from metal ion systems containing Fe⁺⁺⁺, Fe⁺⁺, Ag⁺, Co⁺⁺, Cu⁺⁺ and mixtures thereof.

6. The composition according to claim 1, wherein the catalyst is urea peroxide.

7. The composition according to claim 1, wherein the graft initiator is silver nitrate.

8. A coating composition for the chemical grafting of an oil, fuel, coolant or air filter material, the composition comprises:
about 20-40% by weight of a monomer,
about 20-40% by weight of isopropyl alcohol,
about 20-40% by weight of deionized, distilled or otherwise pure water,
about 4-15% by weight of an ester,
about less than 4% by weight of a catalyst, and
about less than 1% by weight of a graft initiator.

9. The composition according to claim 8, which further comprises about less than 0.5% by weight of a prepolymer.

10. The composition according to claim 9, wherein the prepolymer is a polyacrylamide polymer.

11. The composition according to claim 8, wherein the monomer is 2-acrylamido-2-methylpropanesulfonic acid sodium salt, 50% aqueous solution.

12. The composition according to claim 8, wherein the ester is a monomeric methacrylate ester.

13. The composition according to claim 8, wherein the ester is 2-hydroxyethyl methacrylate.

14. The composition according to claim 8, wherein the catalyst is at least one selected from the group consisting of hydrogen peroxide, urea peroxide, ammonium persulfate, potassium persulfate, sodium metabisulfate and mixtures thereof.

15. The composition according to claim 9, which further comprises about less than 0.5% by weight of a bacteriacide.

16. The composition according to claim 15, wherein the bacteriacide is a carbamate.

17. An oil, fuel, coolant or air filter comprising a filter material and a composition which chemically grafts to the filter material,
wherein the filter material is at least one selected from the group consisting of cotton, paper-based materials, synthetic materials and combinations thereof, and
wherein the composition comprises:
about 20-40% by weight of a monomer,
about 20-40% by weight of isopropyl alcohol,
about 20-40% by weight of deionized, distilled or otherwise pure water,
about 4-15% by weight of an ester,
about less than 4% by weight of a catalyst, and
about less than 1% by weight of a graft initiator.

18. A process for making an oil, fuel, coolant or air filter comprising the steps of:
a. making a composition to chemically graft to a filter substrate,
b. chemically grafting the composition to the filter substrate.

19. The process according to claim 18, wherein the making step comprises:
mixing about 20-40% by weight of deionized, distilled or otherwise pure water,
about 20-40% by weight of a monomer,
about 20-40% by weight of isopropyl alcohol,
about 4-15% by weight of an ester,
about less than 4% by weight of a peroxide-based catalyst, and
about less than 1% by weight of a graft initiator.

20. The process according to claim 19 which further comprises the addition of about less than 0.5% by weight of a prepolymer before mixing in the monomer.

21. The process according to claim 20, wherein the prepolymer is a polyacrylamide polymer mixed with water at temperature between about 60-100 degrees C.

22. The process according to claim 20, wherein the polyacrylamide polymer is mixed with water at temperature between about 60-100 degrees C. and then is mixed with a bateriacide, prior to mixing with any other ingredients.

23. The process according to claim 18, wherein the chemically grafting step comprises:
chemically grafting the composition to the filter substrate by immersing the filter substrate in the composition.

24. The process according to claim 23, wherein the chemically grafting step further comprises:
squeezing the filter substrate to remove excess composition.

25. The process according to claim 18, wherein the chemically grafting step comprises:
chemically grafting the composition to the filter substrate by immersing the filter substrate in the composition, and curing the filter substrate at about 200-300 degrees F.

26. A coating composition for the chemical grafting of an oil, fuel, coolant or air filter material, the composition comprises:
about less than 1% by weight of a polyacrylamide prepolymer,
about 20-40% by weight of deionized, distilled or otherwise pure water,
about 20-40% by weight of mono 2-acrylamido-2-methyl propane sulfonic acid salt, 50% aqueous solution,
about 20-40% by weight of an alcohol-based solvent,
about 4-15% by weight of a monomer ester,
about less than 6% by weight of a catalyst, and
about less than 2% by weight of a graft initiator.

27. A coating composition for the chemical grafting of an oil, fuel, coolant or air filter material, the composition comprises:
about less than 1% by weight of a polyacrylamide prepolymer,
about 20-40% by weight deionized, distilled or otherwise pure water,
about 20-40% by weight mono 2-acrylamido-2-methyl propane sulfonic acid salt, 50% aqueous solution,
about 20-40% by weight isopropyl alcohol,
about 4-15% by weight 2-hydroxy ethyl methacrylate,
about less than 6% by weight of a catalyst, wherein the catalyst is at least one selected from the group consisting of ammonium persulfate, sodium metabisulfate, hydrogen peroxide, and mixtures thereof, and
about less than 2% by weight silver nitrate.

28. An oil, fuel, coolant or air filter comprising a filter material to which is chemically grafted a polymer or copolymer, whereby the chemically grafted polymer or copolymer results from the treatment of a chemical composition to the filter material, and wherein the chemical composition comprises:
about 20-40% by weight of a monomer,
about 20-40% by weight of alcohol,
about 20-40% by weight of deionized, distilled or otherwise pure water,
about 4-15% by weight of an ester,
about less than 6% by weight of a catalyst, and
about less than 2% by weight of a graft initiator.

29. An oil, fuel, coolant or air filter according to claim 28, wherein the filter material is at least one selected from the group consisting of a cellulose-based material, a synthetic material, and combinations thereof.

30. An oil, fuel, coolant or air filter according to claim 29, wherein the cellulose-based material is a cotton material.

31. An oil, fuel, coolant or air filter according to claim 29, wherein the cellulose-based material is a paper material.

32. An oil, fuel, coolant or air filter according to claim 29, wherein the synthetic material is at least one selected from the group consisting of an acrylic, polyester and combinations thereof.

33. A method of filtering oil, fuel, coolant or air comprising:
passing the oil, fuel or air to be filtered through a filter comprising a filter material to which is chemically grafted a polymer or copolymer, whereby the chemically grafted polymer or copolymer results from the treatment of a chemical composition to the filter material, and wherein the chemical composition comprises:
about 20-40% by weight of a monomer,
about 20-40% by weight of isopropyl alcohol,
about 20-40% by weight of deionized, distilled or otherwise pure water,
about 4-15% by weight of an ester,
about less than 6% by weight of a catalyst, and
about less than 2% by weight of a graft initiator.
